(19) United States
(12) Patent Application Publication
(10) Pub. No.: US 2010/0235329 A1
(43) Pub. Date: Sep. 16, 2010

(54) SYSTEM AND METHOD OF EMBEDDING SECOND CONTENT IN FIRST CONTENT

(75) Inventors: DAVID KOREN, RA'ANANA (IL); JUDAH GAMLIEL HAHN, OFRA (IL)

Correspondence Address: BRINKS HOFER GILSON & LIONE/SanDisk, P.O. BOX 10395, CHICAGO, IL, 60610, US

(73) Assignee: SANDISK IL LTD., KFAR SABA (IL)

(21) Appl. No.: 12/720,282

(22) Filed: Mar. 9, 2010

Related U.S. Application Data
(60) Provisional application No. 61/159,034, filed on Mar. 10, 2009.

(51) Int. Cl. G06F 17/00; G06F 15/173; G06F 12/08

(52) U.S. Cl. 707/687; 709/226; 711/126; 707/E17.005; 707/E17.01

(57) ABSTRACT

Apparatus and methods of aggregating content are disclosed. A data storage device includes a host interface, a controller coupled to the host interface, and a memory array coupled to the controller. The host interface is configured to enable the data storage device to be operatively coupled to the host device. First content includes a reference to a source of second content to be embedded in the first content. The first content is retrievable via access to a resource. Upon retrieval, the reference is replaced by the second content such that the second content is embedded in the first content. The controller is configured to receive data of the resource, such received data including the second content embedded in the first content. The controller is also configured to store the received data at the memory array and, when the data storage device is operatively coupled to the host device, provide the second content embedded in the first content to the host device in response to receiving a request for the first content.

### CROSS-REFERENCE TO RELATED APPLICATIONS

This application claims the benefit of U.S. Provisional Application No. 61/159,034, filed Mar. 10, 2009, the content of which is incorporated by reference herein in its entirety. This application is related to co-pending U.S. patent application entitled “SYSTEM AND METHOD OF EMBEDDING SECOND CONTENT IN FIRST CONTENT” having Attorney Docket No. MSA-1313H-US filed concurrently herewith.

### FIELD OF THE DISCLOSURE

The present disclosure is generally related to aggregating content and storing aggregated content at a data storage device.

### BACKGROUND

Use of wireless networks to transmit data as well as voice traffic leads to increased loading on such networks. Transmission of content, such as images and video content, to wireless devices adds further loading and strain on network resources and may lead to bandwidth limitations. For example, a typical hypertext transfer protocol (HTTP) session between a web browser and a corresponding server requires multiple transmission control protocol/internet protocol (TCP/IP) sessions, in which components of a website are downloaded via an iterative data request and response process. Delivery of broadband data while responding to other data requests from a large number of devices during peak periods adds further loading and costs for network operators. In addition, quality of service for voice and data traffic can be impacted by increases in wireless data transmissions. Increased bandwidth requirements to support user-initiated broadband data delivery present challenges to network operators, while increased connection latency and network surcharges impact the user experience. In addition, increasing amounts of broadband data delivered to mobile devices can generate a need for improved data storage capability at the mobile devices.

### SUMMARY

In view of the foregoing, systems and methods of aggregating content are disclosed. An aggregation server may receive a request for content from a mobile device and acquire and store first content in response to the request. Prior to sending the first content to the mobile device, the aggregation server may determine whether the first content indicates that other content should be embedded in the first content. For example, first content from one website may include a command to embed an image within the first content when displayed at a browser of the mobile device. The first content may include a link to the image to be retrieved from a different website. The aggregation server may acquire second content to be embedded in the first content and may modify the first content by embedding the second content. The first content with the embedded second content may be sent by the aggregation server to the mobile device and the first content with the embedded second content may be stored within a data storage device within the mobile device. The data storage device may cache the first content with the embedded second content to be retrievable in response to a request for the first content from the host.

The data storage device may include a host interface to receive aggregated data from a host device, such as the mobile device. A controller within the data storage device may enable storing the received data and providing the modified first content including the embedded second content to the host device in response to receiving a request for the first content. The controller may implement a cache manager to enable storage and retrieval of cached content and to enable conversion of cached content to a user data area of the data storage device.

Because the aggregation server fetches and embeds the second content within the first content prior to sending the first content to the mobile device, the mobile device does not have to generate additional requests for embedded content after receiving the first content. As a result, an amount of time to respond to a request for data (e.g. by selecting a link at a browser) at the mobile device may be reduced, enhancing the user's experience. In addition, an amount of messaging between the mobile device and the aggregation server may be reduced, improving network latency and reducing demands on network resources.

### BRIEF DESCRIPTION OF THE DRAWINGS

FIG. 1 is a block diagram of a first illustrative embodiment of a system including an aggregation server;

FIG. 2 is a block diagram of a second illustrative embodiment of a system including a server device;

FIG. 3 is a block diagram of a third illustrative embodiment of a system including an aggregation server;

FIG. 4 is a block diagram of an illustrative embodiment of a data storage device to cache data;

FIG. 5 is a flow diagram of a first illustrative embodiment of a method of retrieving content at a server;

FIG. 6 is a flow diagram of a second illustrative embodiment of a method of retrieving content at a server;

FIG. 7 is a flow diagram of a third illustrative embodiment of a method of retrieving content at a server;

FIG. 8 is a block diagram of an illustrative embodiment of a system to cache data from a server device;

FIG. 9 is a block diagram of a file system including a discardable files area;

FIG. 10 is a flow diagram of an illustrative embodiment of a method of discarding files; and

FIG. 11 is a data flow diagram of an illustrative embodiment of a data flow of a caching operation.

### DETAILED DESCRIPTION

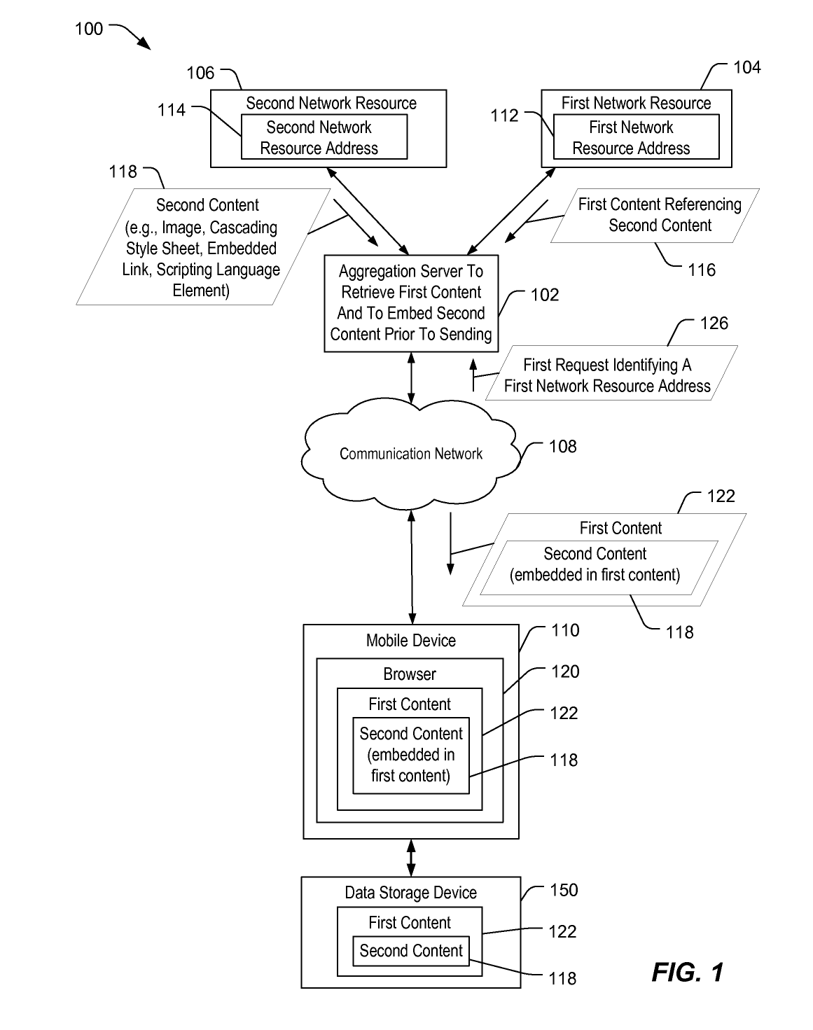

Referring to FIG. 1, a first illustrative embodiment of a system including an aggregation server is depicted and generally designated 100. The system 100 includes a first network resource 104 and a second network resource 106 coupled to the aggregation server 102. The aggregation server 102 may communicate with a representative mobile device 110 via a communication network 108. The mobile device is operatively coupled to a data storage device 150, such as a removable flash memory card. The aggregation server 102 is configured to retrieve first content in response to a request for content from the mobile device 110 and to embed second content into the first content prior to sending the first content to the mobile device 110. As a result, a number of requests for content generated by the mobile device 110 may be reduced and a total amount of communication traffic on the communication network 108 may be reduced.

The communication network 108 may include a wireless communication network. For example, the mobile device 110 may be a wireless device such as a mobile telephone, and the communication network 108 may include a wireless wide area network (WWAN) that enables the representative mobile device 110 to communicate with the aggregation server 102. Although a single representative mobile device 110 is illustrated in the system 100 for clarity of explanation, multiple mobile devices may be coupled to the communication network 108 and configured to generate requests for content that are received at the aggregation server 102. The aggregation server 102 may be coupled to the network resources 104 and 106 via a private data network or a public data network such as the Internet.

The aggregation server 102 is a resource that is remote from the mobile device 110 and that has access to the network resources 104 and 106. The aggregation server 102 is configured to receive a first request 126 identifying a first network resource address. For example, the aggregation server 102 may receive the first request 126 via the communication network 108. The first request 126 may be generated by the mobile device 110, such as in response to a user selection of a hyperlink or other selectable item at a browser 120 of the mobile device 110.

The aggregation server 102 may be configured to retrieve first content 116 from a first network resource 104, the first content 116 referencing second content. For example, the first network resource address identified in the first request 126 received at the aggregation server 102 may be a first network resource address 112 identifying the first network resource 104. The aggregation server 102 may access the first network resource 104 and retrieve the first content 116. The first content 116 may reference second content 118 to be embedded in the first content 116.

The first network resource 104 includes a first network resource address 112, such as an address of a web site, a file transport protocol (FTP) site, one or more other network addresses, or any combination thereof. For example, the first network resource 104 may include one or more servers, such as web servers, that may be accessible to the aggregation server 102 via the first network resource address 112. The first network resource 104 may be responsive to one or more requests or inquiries to provide content, such as the first content 116, that may reference additional content to be embedded within the first content, such as the second content 118 that is accessible at the second network resource 106.

The second network resource 106 includes a second network resource address 114. For example, the second network resource 106 may include one or more servers, such as web servers, that may be accessible to the aggregation server 102 via the second network resource address 114. The second network resource 106 may be responsive to one or more requests or queries from the aggregation server 102 to provide the second content 118 that is stored at or available to the second network resource 106. For example, the second content 118 may include an image, a Cascading Style Sheet (CSS) (trademark), an embedded link, a scripting language element, one or more other content elements, or any combination thereof.

The mobile device 110 may be capable of wireless communication with the aggregation server 102. Examples of a mobile device include a mobile phone, a personal digital assistant (PDA), a gaming device, a media player, an electronic book reader, another mobile device, or any combination thereof. The mobile device 110 may include a browser 120, such as an application executed within a processor of the mobile device 110 to enable Internet information access, retrieval, and display at a display device of the mobile device 110. The browser 120 may be configured to receive first content 122 modified to include the second content 118 via the communication network 108 and in response to receiving the first content 122, to display the first content 122 with the embedded second content 118.

The data storage device 150 may be a removable data storage device that is operatively coupled to the mobile device 110 (e.g. a host device). For example, the data storage device 150 may be a flash memory card, a universal serial bus (USB) flash drive (UFD), or other storage device. The data storage device 150 is responsive to commands from the mobile device 110 to store the first content 122 including the embedded second content 118 and to retrieve the stored first content 122 including the embedded second content 118 for presentation by the mobile device 110 via the browser 120.

During operation, the mobile device 110 may generate the first request 126 identifying the first network resource address 112 and may send the first request 126 via the communication network 108. The first request 126 may be a request to retrieve the first content 116. For example, the first request 126 may request content and may identify the first network resource address 112. The aggregation server 102 may receive the first request 126 and in response may retrieve the first content 116 associated with the first request 126. The aggregation server 102 may determine that the first content 116 identifies the second content 118 to be embedded in the first content 116. For example, the first content 116 may include website content indicating that an image from the second network resource 106 is to be embedded when the first content 116 is displayed at the browser 120 of the mobile device 110.

The second content 118 may be accessible at the second network resource 106 and may be non-accessible at the first network resource address 112. Thus, the aggregation server 102 may generate a request to retrieve the second content 118 from the second network resource 106. In response, the second network resource 106 may enable the aggregation server 102 to retrieve the second content 118. For example, the aggregation server 102 may request the second content 118 from the second network resource 106. The aggregation server 102 may retrieve the second content 118 prior to sending the first content 116 to the mobile device 110. After retrieving the first content 116 and retrieving the second content 118, the aggregation server 102 may replace the reference to the second content (within the first content 116) with the second content 118 such that the second content 118 is embedded in the first content 116 and send the first content 122 including the embedded second content 118 to the mobile device 110.

Upon retrieval of the first content 116 from the aggregation server 102, the second content 118 is embedded in the first content 122. The mobile device 110 may receive the first content 122 with the second content 118 embedded in the first content 122. The first content 122 with the second content 118 embedded in the first content 122 may be provided to the browser 120 or may be stored at the data storage device 150 for later retrieval or playback at the mobile device 110. As a result, the browser 120 may be able to display the first content 122 with the embedded second embedded content 118 in response to sending a single request for data (e.g., the first request 126) as opposed to the mobile device 110 sending a second request to retrieve the second content 118 after receiving the first content 116 that references the second content 118. Thus, data from multiple sources may be provided to the mobile device 110 as a single response to a single request and aggregation of content to be embedded for display may be performed at the aggregation server 102 rather than at the mobile device 110.

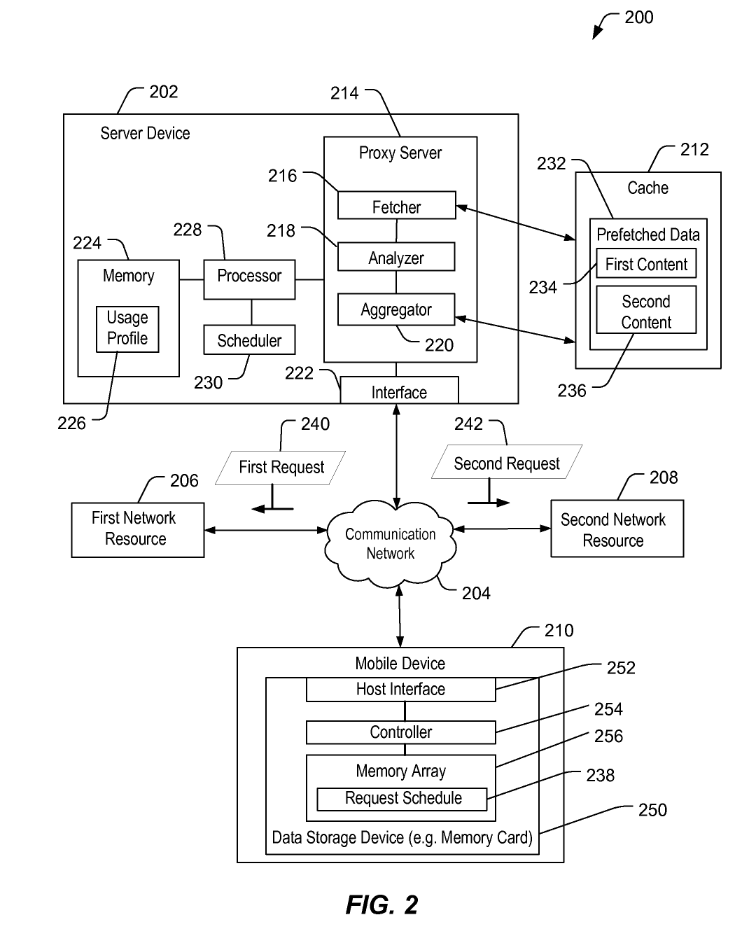

Referring to FIG. 2, a second illustrative embodiment of a system including a server device 202 is depicted and generally designated 200. The system 200 includes the server device 202 that can communicate with a representative mobile device 210 via a communication network 204. The server device 202 may also communicate with a first network resource 206 and a second network resource 208 via the communication network 204. The server device 202 is operatively coupled to a cache 212. The server device 202 may correspond to the aggregation server 102 of FIG. 1, and the mobile device 210 may correspond to the mobile device 110 of FIG. 1.

The server device 202 includes a memory 224 that is accessible to a processor 228. The server device 202 further includes a scheduler 230, a proxy server 214, and an interface 222 that is coupled to enable communication via the communication network 204. The server device 202 may also be configured to communicate with the cache 212 to store data to the cache 212 and to search and fetch data from the cache 212.

The proxy server 214 may be executable at the server device 202 to receive a first request 240 to provide content to the mobile device 210 via the communication network 204. For example, the first request 240 may be received from the mobile device 210 to provide content from a first network resource address that may identify the first network resource 206. The proxy server 214 may be configured to retrieve the first content in response to the first request 240 from the mobile device 210. The first content may identify the second content to be embedded in the first content when the first content is displayed at a browser of the mobile device 210. The second content may be associated with a second network resource address corresponding to the second network resource 208. The proxy server 214 may be configured to retrieve the second content prior to sending the first content to the mobile device 210. The proxy server 214 may be configured to send the first content with the second content embedded in the first content to the mobile device 210.

The proxy server 214 includes a fetcher 216, an analyzer 218, and an aggregator 220. The aggregator 220 is configured to receive the first content and the second content and to embed the second content in the first content. For example, the aggregator 220 may be operatively coupled to the cache 212. The aggregator 220 may be configured to query the cache 212 to determine whether content such as the first content corresponding to a received request is stored at the cache 212. As illustrated, the cache 212 may store the first content 234, such as in response to a previous request from the mobile device 210 or from another mobile device (not shown). When content corresponding to a received request is stored at the cache 212, the aggregator 220 may be configured to retrieve the stored content from the cache 212. Otherwise, when the requested content is not stored at the cache 212, the aggregator 220 may be configured to send at least a portion of the request to the analyzer 218 to identify the content to be retrieved by the fetcher 216.

The analyzer 218 may be configured to receive data corresponding to content to be sent to a remote device. For example, the analyzer 218 may receive content retrieved by the aggregator 220 from the cache 212. The analyzer 218 may be configured to identify an embedded content indicator within the received data and to generate source data indicating a content source associated with the identified embedded content indicator. For example, when the aggregator 220 retrieves the first content 234 from the cache 212, the first content 234 may include one or more indicators of embedded content. To illustrate, the first content 234 may include one or more instructions, such as a hypertext markup language (HTML) instruction, to embed the second content 236 within the first content 234 when displayed at a browser of the mobile device 210. The analyzer 218 may be configured to parse the first content 234 for such indicators of embedded content, to generate source data indicating a content source of the content to be embedded, and to provide the source data to the fetcher 216.

For example, the first content 234 may include an HTML element indicating an embedded object, such as an HTML object tag:

‘OBJECT classid=“second_network_resource_address/filename.ext”’

The analyzer 218 may be configured to parse the first content 234, identify the OBJECT tag, and locate the uniform resource locator (URL) for the source file (indicated by the “classid=” attribute). The analyzer 218 may be configured to store the URL as source data to be provided to the fetcher 216. For example, the source data may be stored as “classid:second_network_resource_address/filename.ext”. The source data includes the URL “second_network_resource_address/filename.ext” that includes the network address “second_network_resource_address” and the file name “filename.ext”. The source data may also include other data, such as values that are appended to the URL as a query string of attributes or tracking data.

As another example, the first content 234 may include an HTML image tag:

‘IMG src=“second_network_resource_address/filename.ext”

The analyzer 218 may be configured to locate the URL for the source file indicated by the “src=” attribute and store the URL as source data to be provided to the fetcher 216.

The fetcher 216 may be configured to receive the source data from the analyzer 218 and to fetch content from an identified content source. For example, the fetcher 216 may receive data indicating the content source from the analyzer 218 and then initiate one or more requests for the content via the communication network 204. For example, the source data received by the fetcher 216 may indicate a network address of the second network resource 208, such as the source data from the object tag: “classid:second_network_resource_address/filename.ext”. In response to receiving the source data from the analyzer 218, the fetcher 216 may generate a request for the second content from the second network resource 208. After receiving the requested content from the second network resource 208, the fetcher 216 may be configured to verify the content and to provide the content to the cache 212. Content stored to the cache 212 can be available to the aggregator 220 for a pending processing request and for potential future requests for the retrieved content.

The aggregator 220 may retrieve data from the cache 212 corresponding to the second content and embed the retrieved data within the first content. For example, the retrieved file “second_network_resource_address/filename.ext” may include class identification information of the object to be embedded, such as “clsid:class_identifier” and data corresponding to the object. The aggregator 220 may rewrite or replace the OBJECT tag to remove the URL and to include inline object information that enables a browser to render the object without referencing filename.ext, such as using a data Uniform Resource Identifier (URI) scheme:

‘OBJECT id=“object_id” classid=“clsid:class_identifier”
data=“data:application/x-oleobject;base64, ...base64 data...”’

The . . . base64 data . . . may be directly retrieved from filename.ext by the aggregator 220 or generated by the aggregator 220 using data retrieved from filename.ext.

Continuing the example where the first content 234 includes the HTML image tag, the aggregator 220 may replace or rewrite the IMG tag to remove the URL and to include inline object information using a data URI scheme:

‘IMG src=“data:image/png;base64, . . . base64 data . . . .”’

Converting HTML elements from referencing a source file to using a data URI scheme is provided as a specific example for purpose of illustration and not of limitation. One or more other techniques may be used by the aggregator 220 to embed the second content within the first content in response to locating an indicator of embedded content within the first content.

The scheduler 230 may be configured to generate instructions to the proxy server 214 to retrieve prefetched data to be cached prior to receiving a request for the data from the mobile device 210. For example, the mobile device 210 may be associated with a usage profile 226. The usage profile 226 may indicate a particular type of content, pattern of interest, or selected type of usage for the mobile device 210. The usage profile 226 may be used to select particular types of content expected to be requested or to be delivered unrequested to users of mobile devices corresponding to the particular usage profile 226. For example, the usage profile 226 may correspond to a hypothetical user that regularly attends the theater to view new movie releases, and the prefetch content that is retrieved for the user of the mobile device 210 may include promotions of new theatrical releases.

The proxy server 214 may be responsive to instructions from the scheduler 230 to retrieve prefetched data 232 to be stored at the cache 212 prior to receiving a request for the prefetched data 232 from the mobile device 210. The prefetched data 232 may include the first content 234, and the first content 234 may include an indication that the second content 236 should be embedded in the first content 234 for use at the mobile device 210. In response to receiving the first content 234, the proxy server 214 may initiate the second request 242 to retrieve the second content 236 from the second network resource 208 after determining that the second content 236 is not already stored at the cache 212. The second content 236 may be retrieved from the second network resource 208 and included with the prefetched data 232 stored at the cache 212.

The scheduler 230 may be synchronized with or responsive to a request schedule 238 of the mobile device 210. For example, the mobile device 210 may have a pre-defined request schedule 238 to retrieve content to be consumed at the mobile device 210. To illustrate, the request schedule 238 may indicate pre-defined times for large amounts of data transmission, such as low usage times to reduce traffic at the communication network 204. As another example, the request schedule 238 may not be a limiting schedule, and may instead be generated based on a pattern of requests made by a user of the mobile device 210. For example, the request schedule 238 may indicate that requests for data transfer have historically been made between the hours of 4:00 p.m.-6:00 p.m. Monday through Friday, and also between the hours of 10:00 a.m.-11:00 a.m. on Saturday and Sunday. The scheduler 230 may be aligned with the request schedule 238 to anticipate an incoming request for content and to retrieve the prefetched data 232 in conjunction with preferences associated with the usage profile 226. The content may be predictively acquired and cached for access of the content by the user to improve the user experience in Internet access operating environments. In addition, traffic on an operator network may be managed by reducing Internet access at peak times by downloading content during off-peak periods. For example, large data transfers may be timed to reduce an impact on voice traffic over a wireless network. Reduced network requirements resulting from predictively caching content during off-peak times may enable reduced cost Internet data access services or subscriptions to individuals or businesses. Cached content may be specifically targeted for a user based on a user profile and may include advertising and promotional data.

The cache 212 may be a network storage device that includes a storage medium and that is accessible to the server device 202. The cache may be co-located with the server device 202. Alternatively, or in addition, the cache 212 may include a portion of the memory 224 of the server device 202 or may include multiple physical devices that are managed as one or more logical cache devices. The cache 212 may provide dedicated storage for content to be accessed by the server device 202 and served to remote devices. Therefore, the cache 212 may be configured to provide the server device 202 with faster access to content than via the communication network 204.

The mobile device 210 is configured to send the first request 240 for content and to receive data including the first content with the embedded second content via the communication network 204. The mobile device 210 is coupled to a data storage device 250. For example, the data storage device 250 may be a flash memory card that is embedded within or removably coupled to the mobile device 210. In other embodiments the data storage device 250 may be external to the mobile device, such as a Universal Serial Bus (USB) flash drive (UFD).

The data storage device 250 may include a host interface 252, a controller 254 coupled to the host interface, and a memory array 256 coupled to the controller 254. The host interface 252 is configured to enable the data storage device 250 to receive data from a host device, illustrated as the mobile device 210, when the data storage device 250 is operatively coupled to the host device. The received data includes the first content 234 modified to include embedded second content, such as the second content 236 embedded in the first content 234 by the aggregator 220.

The controller 254 may be configured to store the received data at the memory array 256. The controller 254 may be further configured to provide the modified first content including the embedded second content to the host device 210 in response to receiving a request for the first content.

The data storage device 250 may store the request schedule 238 at the memory array 256. Data may be received at the data storage device 250 in accordance with the data request schedule 238 stored in the memory array. In another embodiment, the data storage device 250 may store the request schedule 238 at another internal memory (not shown), such as a random access memory (RAM) or read only memory (ROM) of the controller 254. The received data may be prefetched data that is selected according to the usage profile 226 independent of a user request for the first content.

Although the data storage device 250 is illustrated as a memory card, such as having the memory array 256 of NAND flash memory cells or NOR flash memory cells, in other embodiments the data storage device 250 may include a type of memory other than flash memory, such as a hard disc drive or a writable optical memory, as illustrative, non-limiting examples.

Although the first content 234 and the second content 236 are illustrated as included in the prefetched data 232, the first content 234 or the second content 236, or both, may not be prefetched. For example, the first content 234 or the second content 236 may be retrieved and stored at the cache 212 in response to a request for content prior to the scheduler 230 initiating a data prefetch operation to retrieve the content 234, 236 from the network resources 206, 208. Data to be prefetched according to the usage profile 226 may be identified as already being located at the cache 212 prior to performing a fetch from the network resources 206, 208.

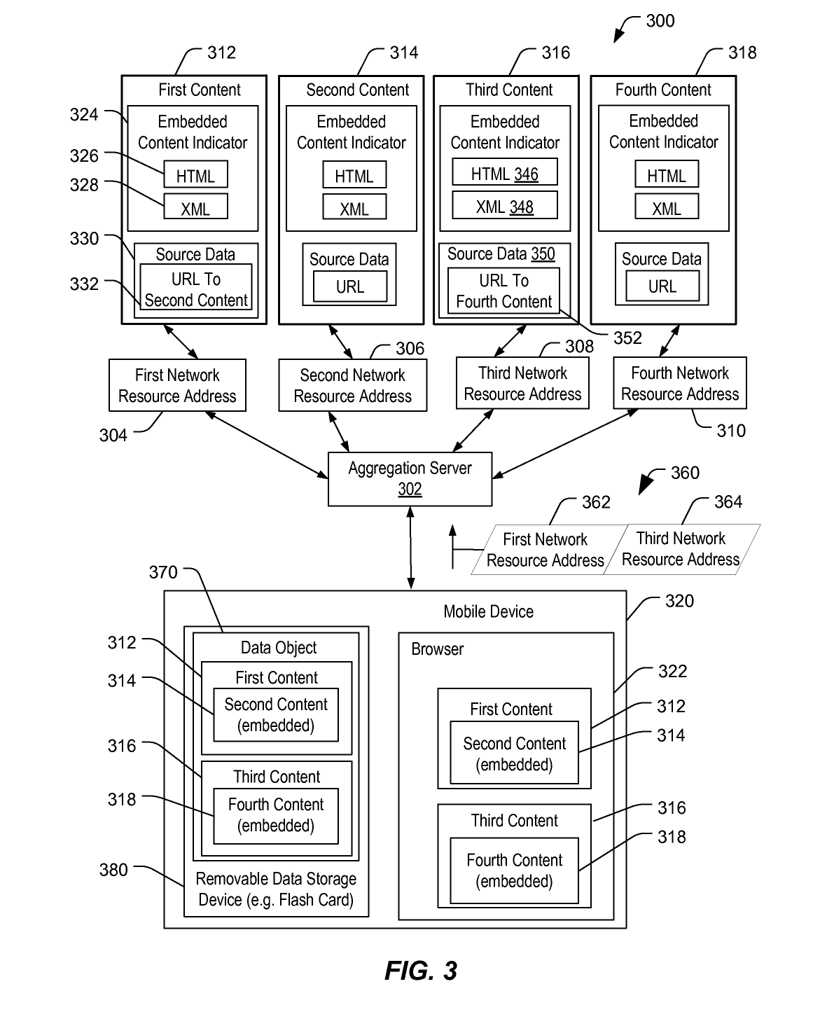

Referring to FIG. 3, a third illustrative embodiment of a system including an aggregation server 302 is depicted and generally designated 300. The system 300 includes the aggregation server 302 in communication with a mobile device 320. The aggregation server 302 is configured to receive first content 312 via a first network resource address 304, second content 314 via a second network resource address 306, third content 316 via a third network resource address 308, and fourth content 318 via a fourth network resource address 310. For example, the aggregation server 302 may correspond to the aggregation server 102 of FIG. 1, the server device 202 of FIG. 2, or a combination thereof.

The aggregation server 302 may be configured to receive a request that includes multiple pipelined requests 360. For example, a first pipelined request 362 may include the first network resource address 304 and a second pipelined request 364 may include the third network resource address 308. The aggregation server 302 may be configured to initiate a keep-alive connection to maintain an open session with the mobile device 320. The aggregation server 302 may be configured to process the multiple pipelined requests 362 and 364. To illustrate, the aggregation server 302 may be configured to retrieve the first content 312 corresponding to the first network resource address 304. For example, the first content 312 may be retrieved from a cache, such as the cache 212 of FIG. 2, or may be retrieved from a network resource via a communication network, such as via the communication network 204 of FIG. 2.

The aggregation server 302 may be configured to parse the retrieved first content 312 to detect one or more embedded content indicators, such as an embedded content indicator 324. The embedded content indicator 324 may indicate source data 330 that includes a uniform resource locator (URL) 332 to the second content 314. The embedded content indicator 324 may include one or more hypertext markup language (HTML) elements 326, such as indicated by an image (IMG) tag, a cascading style sheet (CSS) tag, or one or more other tags. Alternatively, or in addition, the embedded content indicator 324 may include one or more extensible markup language (XML) elements 328 or other indicator to embed content.

The aggregation server 302 may be configured to identify the embedded content indicator 324, to identify the source data 330 associated with the embedded content indicator 324, and to retrieve second content corresponding to the URL 332 within the source data 330. For example, the URL 332 of the second content may correspond to content that is already stored at a cache (not shown) for retrieval by the aggregation server 302 or to content that may be retrieved by the aggregation server 302 via a signal to the second network resource address 306. To illustrate, the second network resource address 306 may correspond to at least a portion of the URL 332.

The aggregation server 302 may retrieve the second content 314 to be embedded within the first content 312, such as via a cache access or via a request to the second network resource address 306. The second content 314 may also include one or more embedded content indicators and corresponding source data that may include one or more URLs of additional content to be embedded within the second content 314. The aggregation server 302 may be configured to parse the second content 314, locate one or more embedded content indicators, and retrieve additional content to be consumed with the second content 314 at an end-user device.

The aggregation server 302 may be configured to retrieve the third content 316 in response to the second pipelined request 364 identifying the third network resource address 308, such as by accessing the third network resource address 308 via a communication network or from a cache (not shown). The aggregation server 302 may be configured to parse the third content 316 for embedded content indicators, such as an HTML element 346 or an XML element 348, to identify source data 350 indicating a source of the content to be embedded, such as a URL 352 to the fourth content 318. The aggregation server 302 may be configured to retrieve the fourth content 318 in a similar manner as described with respect to retrieving the second content 314.

The aggregation server 302, after retrieving the first content 312, the second content 314, the third content 316 and the fourth content 318, may embed the second content 314 in the first content 312 and may embed the fourth content 318 in the third content 316. For example, the aggregation server 302 may locate the embedded content indicator 324 and the source data 330, may remove the embedded content indicator 324 and the source data 330, and may insert the second content 314 at a location where the embedded content indicator 324 was removed. Similarly, the aggregation server 302 may parse the third content 316 to locate the embedded content indicator and the source data 350 and may replace the embedded content indicator and the source data 350 corresponding to the fourth content 318 with the fourth content 318 at a location where the embedded content indicator was removed.

The aggregation server 302 may generate a data object 370 that includes the first content 312 with the embedded second content 314 and that also includes the third content 316 with the embedded fourth content 318. The aggregation server 302 may send the data object 370 as a single transmission data object to the mobile device 320 in response to the multiple pipelined requests 362, 364 and within the same keep-alive communication session with the mobile device 320 that was initiated in response to the request including the multiple pipelined requests 360.

The mobile device 320 may be configured to receive the data object 370 and to store the data object 370 to a removable data storage device 380, such as a flash memory card. The removable data storage device 380 may correspond to the data storage device 250 of FIG. 2. To illustrate, the received data including the first content 312 modified to include the embedded second content 314 and the third content 316 modified to include the embedded fourth content 318 may be received from the host device as the single data object 370.

The mobile device 320 may be configured to provide the first content 312 with the embedded second content 314 to a browser 322. The mobile device 320 may also be configured to provide the third content 316 with the embedded fourth content 318 to the browser 322 or to one or more other requesting applications or devices at the mobile device 320, such as a music player, a video player, an electronic book reader, or any combination thereof. For example, the mobile device 320 may be configured to send a request to the removable data storage device 380 for the first content 312, the third content 316, or a combination thereof.

The removable data storage device 380 may be configured to receive data from a host device, such as the mobile device 320, when the data storage device 350 is operatively coupled to the host device. The removable data storage device 380 stores the received data, such as data including the first content 312 modified to include the embedded second content 314 and the third content 316 modified to include the embedded fourth content 318. The removable data storage device 380 provides the modified first content 312 including the embedded second content 314 to the mobile device 320 in response to receiving a request for the first content 312. The removable data storage device 380 also provides the modified third content 316 including the embedded fourth content 318 to the mobile device 320 in response to receiving a request for the third content 316.

By generating and sending the pipeline requests 362, 364 to the aggregation server 302, an amount of data signaling and message transmission between the mobile device 320 and the aggregation server 302 may be reduced. Similarly, by sending the single data object 370 including all content requested by the mobile device 320 and all content embedded within the requested content, the requested content may be received via a single transmission session. As a result, fewer messages are required to be sent from the mobile device 320 since aggregation of content to be embedded for display may be performed at the aggregation server 302.

Although FIGS. 1-3 illustrate that mobile devices may generate requests for content and receive data including the requested content and embedded content, in other embodiments such requests may be made and content received by devices other than mobile devices. Although the systems illustrated in FIGS. 1-3 are illustrated including a representative mobile device, any of the systems of FIGS. 1-3 may support multiple devices in communication with one or more content aggregation servers. Although the networks 108 and 204 of FIGS. 1 and 2 are each depicted as a single communication network, in other embodiments one or more of the networks 108 or 204 may include multiple networks including multiple network components and may include one or more wireless network portions, one or more wireline network portions, or any combination thereof.

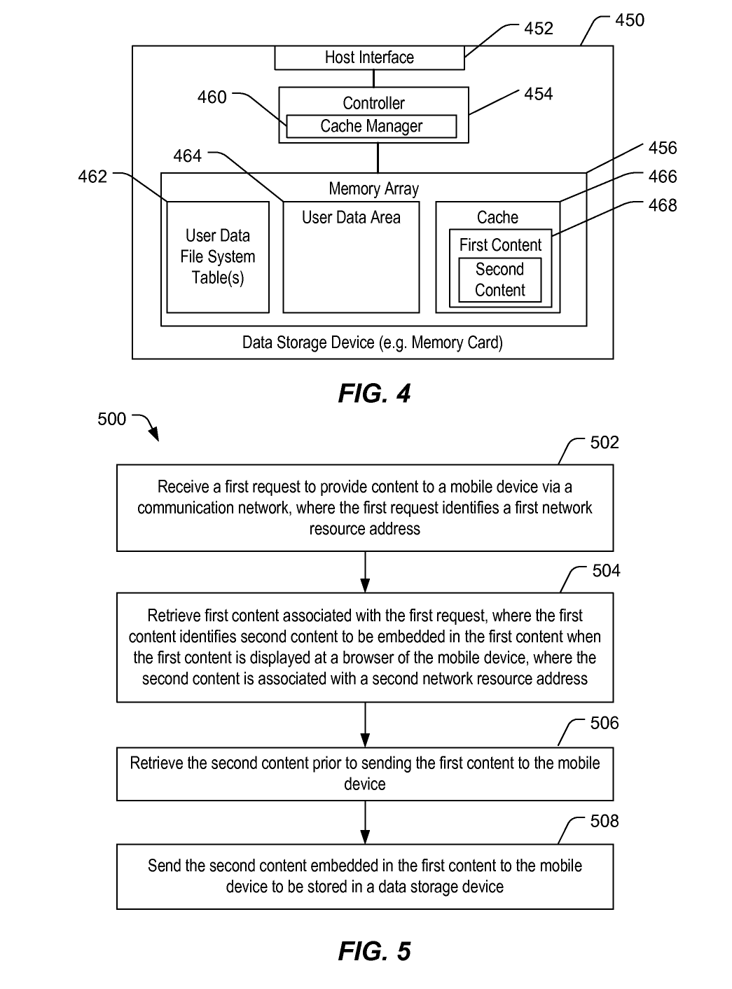

FIG. 4 depicts a particular embodiment of a data storage device 450 that is configured to store received data 468 including first content modified to include embedded second content. The data storage device 450 includes a host interface 452, a controller 454 coupled to the host interface 452, and a memory array 456 coupled to the controller 454. The data storage device 450 may be the data storage device 150 of FIG. 1, the data storage device 250 of FIG. 2, or the removable data storage device 380 of FIG. 3, as illustrative examples.

The host interface 452 is configured to enable the data storage device 450 to receive the data 468 from a host device (e.g. the mobile device 110 of FIG. 1) when the data storage device 450 is operatively coupled to the host device. For example, the host interface 452 may include a physical bus interface including one or more electrical contacts to enable signal propagation from a host device to the data storage device 450 via a bus. To illustrate, the host interface 452 may include three contact pads to receive power supply signals, four contact pads to receive data signals, a contact pad to receive a clock signal, and a contact pad to receive command signals, such as in a Secure Digital (SD) configuration. The host interface 452 may further include one or more buffers and associated circuitry to convert received electrical signals to digital data that is provided to the controller 454.

The received data 468 includes the first content modified to include the embedded second content. For example, the first content may be the first content 116 of FIG. 1 that is retrievable via access to a first network resource address at a data network accessible to the host device, and the first content 116 includes a reference to a source of the second content (e.g. the second content 118 of FIG. 1) to be embedded in the first content.

The controller 454 is configured to store the received data 468 at the memory array 456. For example, the controller 454 may be configured to store the received data 468 at a cache 466 of the memory array 456. The controller 454 is also configured to provide the modified first content including the embedded second content to the host device in response to receiving a request for the first content. To illustrate, the controller 454 is responsive to a request for the first content by retrieving the data 468 including the embedded second content from the memory array 456 and sending the retrieved data 468 to a requestor via the host interface 452.

The data storage device 450 includes one or more user data file system tables 462 that correspond to a user data area 464 in the memory array 456. The memory array 456 is illustrated as including the cache 466 outside of the user data area 464 for storing downloaded content that may not be immediately retrievable by a user. To illustrate, the data 468 may be stored to the cache 466 and may not be available for consumption until a particular condition is met, such as a digital rights management (DRM) condition. The cache 466 may be implemented in a separate partition than the user data area 464, such as a hidden or secure partition. In the alternative, the cache 466 and the user data area 464 may be implemented in a common partition, i.e., in the same partition.

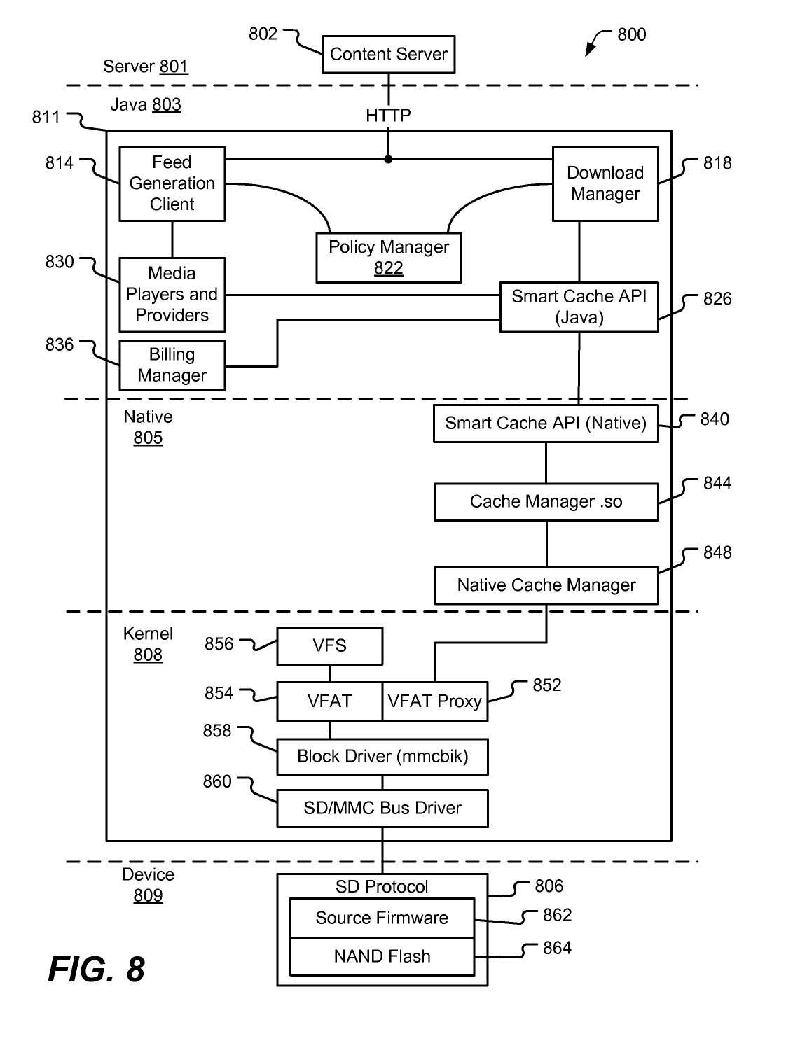

In a first embodiment, the cache 466 may be managed by an external host device. An example of a system including a host device configured to manage a cache at a data storage device is described with respect to FIG. 8. The controller 454 may be responsive to host commands such as data write and read commands that designate clusters or sectors corresponding to the memory array 456. For example, the controller 454 may map logical clusters or sectors indicated by a host device to physical locations at the memory array 456. The host may read the user data file system tables 462, update the user data file system tables 462, and store the updated user data file system tables 462 to the memory array 456.

In the illustrated embodiment, rather than the cache 466 being managed by a host, the controller 454 includes a cache manager 460 to control management of the cache 466. The cache manager 460 may be implemented as executable code that may be stored at the controller 454, e.g. at a read-only memory (ROM) (not shown), or at the memory array 456, and that is executed by the controller 454. The cache manager 460 may be responsive to received commands to add a file (e.g. a file that includes the data 468) to the cache 466, to remove items from the cache 466, and to convert cached items to user data items.

For example, the cache manager 460 may be responsive to a command received via the host interface 452 to add the data 468 to the cache 466. The data 468 may be identified to the cache manager 460 as including the first content. The cache manager 460 may store the data 468 to the cache 466 and update a cache index or table of cached content (or other type of cache file system) to include a reference to the first content. The cache manager 460 may index the received data 468 to be retrievable in response to a request for the first content, even though the received data 468 also includes the second content embedded in the first content. For example, the cache manager 460 may index the received data 468 using a URL of the first content.

The cache manager 460 may be responsive to a command received via the host interface 452 to render the first content accessible by writing the received data 468 to the user data area 464 to the cache 466. For example, the cache manager 460 may be configured to search a cache index or table of cached content for a reference to the first content, read location data from the cache index or table to locate the data 468 in the cache 466, and read the located data 468 from the cache 466. The controller 454 may be configured to locate one or more physical locations at the user data area 464 with sufficient size to store the data 468, and the controller 454 may write the data 468 to the user data area 464 at the physical locations.

In addition, the controller 454 may update the user data file system tables 462 to indicate the first content within the user data area 464. For example, in an embodiment where the user data file system tables 462 include one or more cluster maps and one or more directory tables, such as a file allocation table (FAT) file system, the controller 454 may update entries in the one or more cluster maps to indicate the corresponding clusters as storing user data. The controller 454 may also update the one or more directory tables to indicate a file name for the data 468, such as a name of the first content, and to indicate a starting cluster of the data 468.

The controller 454 may be configured to send a message to the host after updating the user data file system tables 462. For example, if the host has previously loaded the user data file system tables 462 from the data storage device 450, the controller 454 may send the message to cause the host to load the updated user data file system tables 462 to obtain updated file system information. The message may be a dedicated command to reload the file system tables 462 or may be an indicator to the host that updated information is available from the data storage device 450. In an embodiment where the controller 454 performs logical-to-physical address translation, the controller 454 may add or update one or more entries within a logical-to-physical translation table to map clusters updated at the user data file system tables 462 to physical locations where the data 468 is stored. After writing the data 468 to the user data area 464, the cache manager 460 may update the cache index or table to identify the data 468 as no longer available at the cache 466 and may designate the physical location(s) of the cache storing the data 468 as unused or as not storing valid data.

After writing the data 468 to the user data area 464 from the cache 466, the controller 454 may be configured to provide the modified first content that includes the embedded second content from the user data area 464 to the host device in response to receiving a request for the first content. For example, in an embodiment where the controller 454 performs logical-to-physical address translation, the controller 454 may receive a request indicating a logical address associated with the data 468, the controller 454 may access one or more entries within a logical-to-physical translation table to determine one or more physical locations of the user data area 464 corresponding to the logical address, and may provide read access to the data 468 at the determined physical locations. In other embodiments, such as a flash file system embodiment, the controller 454 may receive a request including a name of the first content and may search the user data file system tables 462 to locate the data 468.

Although the cache manager 460 is described as being responsive to commands from a host device, the cache manager 460 may alternatively or additionally be responsive to a network content server, such as the aggregation server 102 of FIG. 1 or the proxy server 214 of FIG. 2. For example, the controller 254 of FIG. 2 may include the cache manager 460. The cache manager 460 may be configured to establish an Internet Protocol (IP) session with the proxy server 214 via the mobile device 210 to receive the data 468 according to the usage profile 226 and the request schedule 238.

Although the data storage devices of FIGS. 1-4 are described as receiving data that includes second content embedded within the first content, such as data of the remote aggregation server 102 of FIG. 1 received via the mobile device 110, in other embodiments the data storage device may instead generate at least one of the first content and the second content. For example, the data storage device 450 of FIG. 4 may run an active process that originates the first content, the second content, or both. In addition, the data storage device 450 may include a resource such as an aggregation server that embeds second content within first content by locating a reference to the second content in the first content and replacing the reference with the second content such that the second content is embedded in the first content. To illustrate, the controller 454 may execute program instructions to run the local aggregation server process and/or to run the active process that generates content. The controller 454 may be configured to receive data that has the second content embedded in the first content from the local aggregation server and to store the received data at the memory array 456, such as at the cache 466.

A data storage device may therefore receive first content and second content and store the first content and the second content as data that includes the second content embedded in the first content. In some embodiments, the second content may be embedded in the first content when the data is received from a remote resource, such as from the remote aggregation server 102 of FIG. 1. In other embodiments, the first content and the second content may be provided to a local resource, such as a local aggregation server at the data storage device. One or both of the first content and the second content may be received via a host interface or may be generated at the data storage device. Upon retrieval from the local resource, the retrieved data may include the second content embedded within the first content. For example, the cache manager 460 of FIG. 4 may receive the data and store the received data at the cache 466. In response to receiving a request for the first content, the data storage device may provide the second content embedded in the first content to the host device. As a result, a browser at the host device may be able to use the aggregated content without sending requests for additional content to be embedded and without having to embed additional content prior to display.

Referring to FIG. 5, a flowchart of an illustrative embodiment of a method of retrieving content is depicted and generally designated 500. As an illustrative example, the method 500 may be performed at an aggregation server coupled to a communication network, such as the aggregation server 102 of FIG. 1, the server device 202 of FIG. 2, the aggregation server 302 of FIG. 3, or any combination thereof.

A first request to provide content to a mobile device may be received at the aggregation server via the communication network, at 502. The first request may identify a first network resource address, such as the first network resource address 112 of FIG. 1. For example, the first network resource address 112 identified in the first request 126 may be an address identifying a first network resource, such as an Internet Protocol (IP) or Media Access Control (MAC) address of the first network resource 104 of FIG. 1. The first network resource 104 may include the first network resource address 112, which may correspond to an address of a web site, an FTP site, one or more other network addresses, or any combination thereof. Alternatively, or in addition, the aggregation server may be configured to predictively acquire or prefetch content prior to receiving a request for at least a portion of the content, and the predictively acquired or prefetched content may be stored in a cache associated with or accessible to the aggregation server.

Continuing to 504, first content associated with the first request is retrieved. The first content identifies second content to be embedded in the first content when the first content is displayed at a browser of a mobile device, such as the browser 120 of the mobile device 110 of FIG. 1. The second content, such as the second content 118 of FIG. 1, may be associated with a second network resource address, such as the second network resource address 114 of FIG. 1.

As an illustrative example, the first content may be retrieved by generating a request for content and sending the request for content to the first network resource address. The request for content indicates a return address of the aggregation server to which the content is to be sent. To illustrate, the request for content may include a HTTP GET command that is sent by the aggregation server via a Transport Control Protocol (TCP) session established between the aggregation server and the first network resource.

As another example, the first content may be retrieved by querying a cache for the first content, and the first content may be retrieved from the cache if available. To illustrate, the first network resource address (e.g. a URL of the requested content) may be provided within a query that is sent to the cache to initiate a cache lookup operation. In response to the cache containing a data entry corresponding to the first network resource address (i.e. a cache hit), the first content may be sent from the cache to the aggregation server.

Advancing to 506, the second content may be retrieved prior to sending the first content to the mobile device. For example, the first content may be parsed to identify one or more indicators of embedded content. In response to locating an indicator of embedded content that identifies the second content, a request for the second content may be generated and sent to the second network resource address. The request for the second content may indicate a return address of the aggregation server to which the second content is to be received. To illustrate, the request for the second content may include a HTTP GET command that is sent by the aggregation server via a Transport Control Protocol (TCP) session established between the aggregation server and the second network resource.

As another example, the second content may be retrieved by querying a cache for the second content, and the second content may be retrieved from the cache if available. To illustrate, the second network resource address (e.g. a URL of the requested content) may be provided within a query that is sent to the cache to initiate a cache lookup operation. In response to the cache containing a data entry corresponding to the second network resource address (i.e. a cache hit), the second content may be sent from the cache to the aggregation server.

Moving to 508, the second content embedded in the first content, such as the first content including the embedded second content 122 of FIG. 1, are sent to the mobile device. For example, after retrieving the first content from the first network resource or a cache, and after retrieving the second content from the second network resource or a cache, the aggregation server may embed the second content in the first content, and send the first content including the embedded second content to the mobile device. To illustrate, the aggregation server may parse the first content and locate one or more indicators of embedded content, such as an HTML instruction to embed the second content within the first content. The aggregation server may remove or modify the indicator corresponding to the second content and may insert the second content at the location of the indicator.

The mobile device may receive the first content including the embedded second content. As a result, a browser of the mobile device may be able to display the first content including the embedded second content in response to receiving a single request for data, and without being required to send a second request to retrieve the second content after receiving the first content that references the second content. As a result, fewer messages are sent from the mobile device, and instead aggregation of content from multiple sources is performed at the aggregation server.

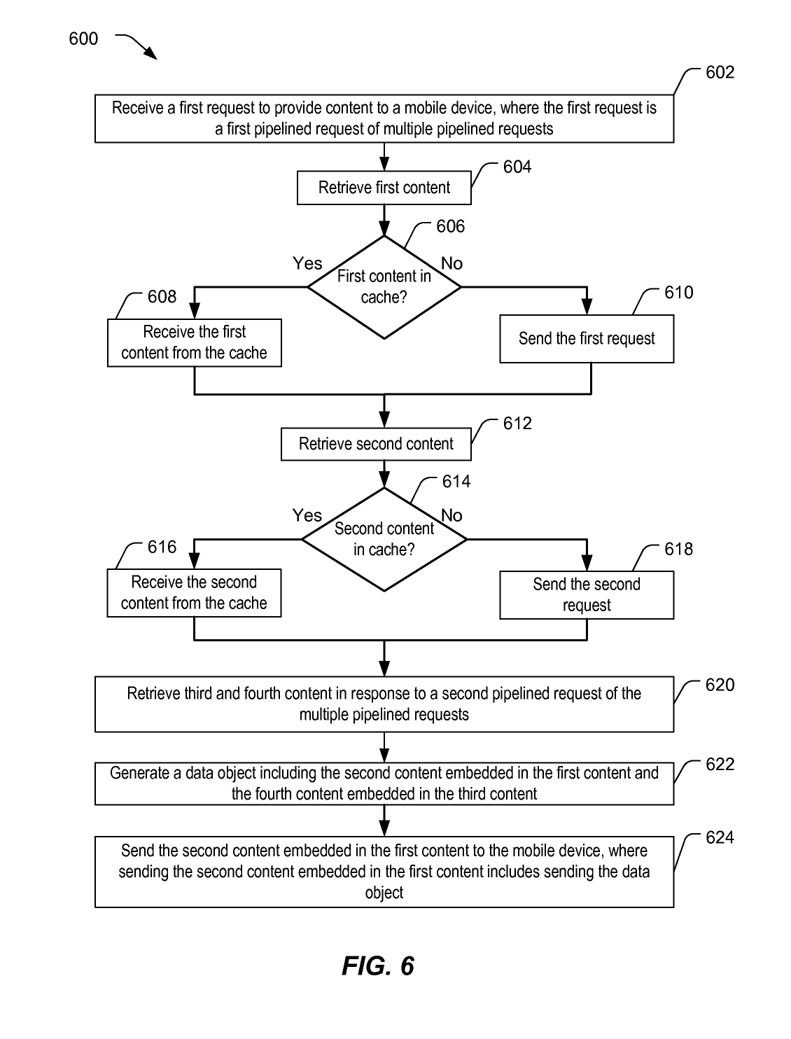

Referring to FIG. 6, a flowchart of a second illustrative embodiment of a method of retrieving content is depicted and generally designated 600. As an illustrative example, the method 600 may be performed at an aggregation server coupled to a communication network, such as the aggregation server 102 of FIG. 1, the proxy server 214 of FIG. 2, the aggregation server 302 of FIG. 3, or any combination thereof.

A first request to provide content to a mobile device may be received at the aggregation server via the communication network, at 602. The first request may include a first pipelined request of multiple pipelined requests. The first request may identify a first network resource address, such as the first network resource address 112 of FIG. 1. For example, the first network resource address 112 identified in the first request 126 may be an address identifying a first network resource, such as an Internet Protocol (IP) or Media Access Control (MAC) address of the first network resource 104 of FIG. 1. The first network resource 104 may include the first network resource address 112, which may correspond to an address of a web site, an FTP site, one or more other network addresses, or any combination thereof. Alternatively, or in addition, the aggregation server may be configured to predictively acquire or prefetch content prior to receiving a request for at least a portion of the content, and the predictively acquired or prefetched content may be stored in a cache associated with or accessible to the aggregation server.

Continuing to 604, the method includes retrieving first content associated with the first request, where the first content identifies second content to be embedded in the first content when the first content is displayed at a browser of a mobile device, such as the browser 120 of the mobile device 110 of FIG. 1. The second content, such as the second content 118 of FIG. 1, may be associated with a second network resource address, such as the second network resource address 114 of FIG. 1.

For example, the first content may be retrieved by querying a cache for the first content, at 606. The first content may be retrieved from the cache if available, at 608. To illustrate, the first network resource address (e.g. a URL of the requested content) may be provided within a query that is sent to the cache to initiate a cache lookup operation. In response to the cache containing a data entry corresponding to the first network resource address (i.e. a cache hit), the first content may be sent from the cache to the aggregation server.

If the first content is not available at the cache, then the first content may be retrieved by generating a request for content and sending the request for content to the first network resource address, at 610. The request for content indicates a return address of the aggregation server to which the content is to be sent. To illustrate, the request for content may include a HTTP GET command that is sent by the aggregation server via a Transport Control Protocol (TCP) session established between the aggregation server and the first network resource.

Continuing to 612, the method includes retrieving the second content associated with the first request. For example, the second content may be retrieved by querying a cache for the second content, at 614. The second content may be retrieved from the cache if available, at 616. To illustrate, the second network resource address (e.g. a URL of the requested content) may be provided within a query that is sent to the cache to initiate a cache lookup operation. In response to the cache containing a data entry corresponding to the second network resource address (i.e. a cache hit), the second content may be sent from the cache to the aggregation server.

If the second content is not available at the cache, then the second content may be retrieved prior to sending the first content to the mobile device. For example, the first content may be parsed to identify one or more indicators of embedded content. In response to locating an indicator of embedded content that identifies the second content, a request for the second content may be generated and sent to the second network resource address, at 618. The request for the second content may indicate a return address of the aggregation server to which the second content is to be received. To illustrate, the request for the second content may include a HTTP GET command that is sent by the aggregation server via a Transport Control Protocol (TCP) session established between the aggregation server and the second network resource.

Proceeding to 620, a second request to provide content to the mobile device may be received at the aggregation server via the communication network. The second request may include a second pipelined request of the multiple pipelined requests, such as the second pipelined request 364 of FIG. 3. The second request may identify a third network resource address, such as the third network resource address 308 of FIG. 3. For example, the third network resource address 308 identified in the second request may be an address identifying a third network resource such as an Internet Protocol (IP) or Media Access Control (MAC) address of the third network resource. The third network resource may include the third network resource address 308, which may correspond to an address of a web site, an FTP site, one or more other network addresses, or any combination thereof. Alternatively, or in addition, the aggregation server may be configured to predictively acquire or prefetch content prior to receiving a request for at least a portion of the content, and the predictively acquired or prefetched content may be stored in a cache associated with or accessible to the aggregation server.

The method includes retrieving third content associated with the second request, where the third content identifies fourth content to be embedded in the third content when the third content is displayed at the browser of the mobile device, such as the browser 322 of the mobile device 320 of FIG. 3. The retrieval of the third and fourth content may be performed in a similar manner as described with respect to retrieving the first and second content described above.

Advancing to 622, a data object including the second content embedded in the first content and the fourth content embedded in the third content is generated. For example, the data object 370 may be generated at the aggregation server 302 that includes the first content 312 with the embedded second content 314 and that also includes the third content 316 with the embedded fourth content 318.

Continuing to 624, the data object 370, including the second content embedded in the first content, may be sent by the aggregation server 302 to the mobile device 320 in response to the first and second requests. The data object may be sent as a single transmission data object, and may be sent within the same keep-alive communication session with the mobile device 320 that was initiated in response to the request to provide content including the multiple pipelined requests 360.

The mobile device 320 may receive the data object 370 and provide the first content 312 with the embedded second content 314 to the browser 322. The data object 370 may be stored within the data storage device 380. The mobile device 320 may also provide the third content 316 with the embedded fourth content 318 to the browser 322 or to one or more other requesting applications or devices at the mobile device 320.

As a result of generating and sending pipelined requests, an amount of data signaling and message transmission between the mobile device and the aggregation server may be reduced. Similarly, by sending a single data object including content requested by the mobile device and content embedded within the requested content, requested content from multiple sources may be received via a single transmission session. As a result, fewer messages are required to be sent from the mobile device, and aggregation of content to be embedded for display may be performed at the aggregation server.

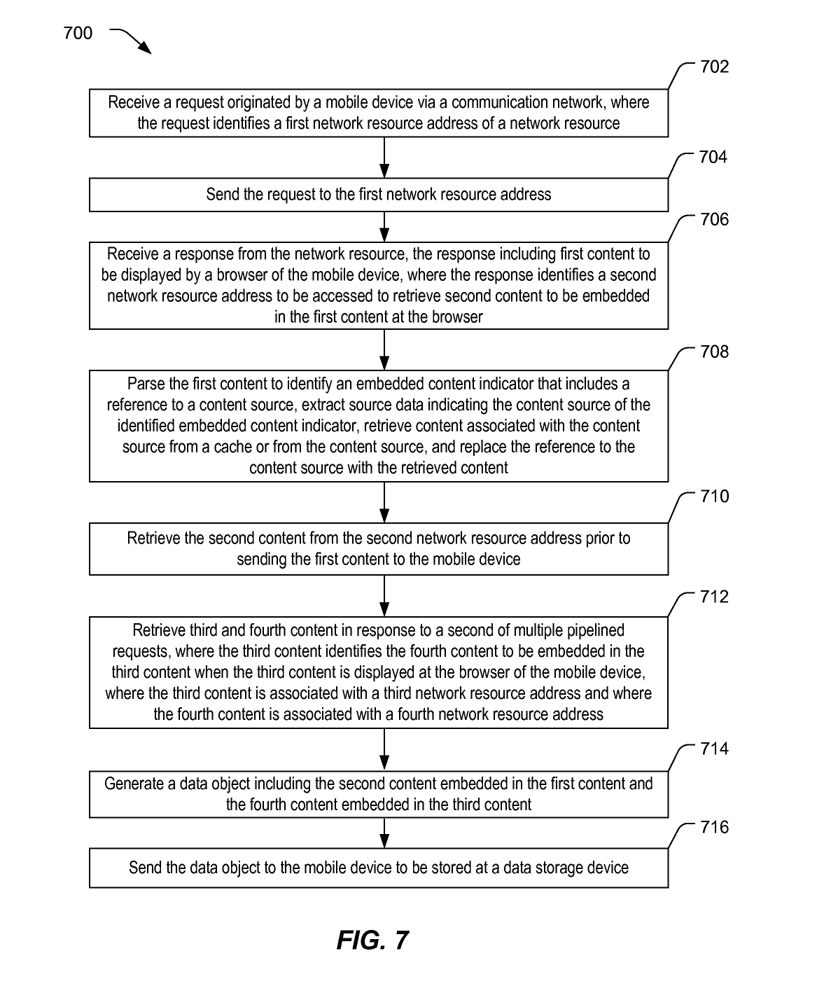

Referring to FIG. 7, a flowchart of a second illustrative embodiment of a method of retrieving content is depicted and generally designated 700. As an illustrative example, the method 700 may be performed at an aggregation server coupled to a communication network, such as the aggregation server 102 of FIG. 1, the server device 202 of FIG. 2, the aggregation server 302 of FIG. 3, or any combination thereof.

A request originated by a mobile device to access content may be received at the aggregation server via the communication network, at 702. The request may identify a first network resource address, such as the first network resource address 304 of FIG. 3. For example, the first network resource address 304 identified in the request may be an address identifying a first network resource, such as an Internet Protocol (IP) or Media Access Control (MAC) address of a first network resource. The first network resource may include the first network resource address 304, which may correspond to an address of a web site, an FTP site, one or more other network addresses, or any combination thereof. Alternatively, or in addition, the aggregation server may be configured to predictively acquire or prefetch content prior to receiving a request for at least a portion of the content, and the predictively acquired or prefetched content may be stored in a cache associated with or accessible to the aggregation server.

Continuing to 704, the request for content may be sent to the first network resource address 304. The request for content may indicate a return address of the aggregation server to which the content is to be sent, such as the aggregation server 302 of FIG. 3. To illustrate, the request for content may include a HTTP GET command that is sent by the aggregation server 302 via a Transport Control Protocol (TCP) session established between the aggregation server 302 and the first network resource.

Advancing to 706, a response from the first network resource may be received by the aggregation server 302. The response may include first content associated with the first request, such as the first content 312 of FIG. 3. The first content 312 identifies second content to be embedded in the first content when the first content is displayed at a browser of a mobile device, such as the browser 322 of the mobile device 320 of FIG. 3. The second content, such as the second content 314 of FIG. 3, may be associated with a second network resource address, such as the second network resource address 306 of FIG. 3.

Proceeding to 708, the method includes parsing the first content to identify an embedded content indicator that includes a reference to a content source, extracting source data indicating the content source of the identified embedded content indicator, retrieving content associated with the content source from a cache or from the content source, and replacing the reference to the content source with the retrieved content.

For example, the first content 312 may be parsed to identify one or more indicators of embedded content, such as the embedded content indicator 324 of FIG. 3. An embedded content indicator may identify source data that indicates a content source. The embedded content indicator may include a uniform resource locator (URL) to the second content, such as the URL 332 of FIG. 3. The embedded content indicator may include one or more hypertext markup language (HTML) elements, such as indicated by an image (IMG) tag, a cascading style sheet (CSS) tag, or one or more other tags, such as the HTML elements 326 of FIG. 7. Alternatively, or in addition, the embedded content indicator may include one or more extensible markup language (XML) elements, such as the XML element 328 of FIG. 3, or other indicators to embed content.

In response to locating an indicator of embedded content that identifies the second content, the aggregation server may be configured to retrieve second content corresponding to the indicator (e.g., a URL) within the source data. For example, the URL of the second content may correspond to content that is already stored at a cache for retrieval by the aggregation server or to content that may be retrieved by the aggregation server via a signal to the second network resource address, such as the second network resource address 306 of FIG. 3. To illustrate, the second network resource address 306 may correspond to at least a portion of the URL 332. For example, the aggregation server 302 may locate the embedded content indicator 324 and the source data 330, may remove the embedded content indicator 324 and the source data 330, and may insert the second content 314 at a location where the embedded content indicator 324 was removed.

Moving to 710, the second content may be retrieved from the second resource address prior to sending the first content to the mobile device. For example, in response to locating an indicator of embedded content that identifies the second content, a request for the second content may be generated and sent to the second network resource address. The request for the second content may indicate a return address of the aggregation server to which the second content is to be received. To illustrate, the request for the second content may include a HTTP GET command that is sent by the aggregation server via a Transport Control Protocol (TCP) session established between the aggregation server and the second network resource.

As another example, the second content may be retrieved by querying a cache for the second content, and the second content may be retrieved from the cache if available. To illustrate, the second network resource address (e.g. a URL of the requested content) may be provided within a query that is sent to the cache to initiate a cache lookup operation. In response to the cache containing a data entry corresponding to the second network resource address (i.e. a cache hit), the second content may be sent from the cache to the aggregation server.

Proceeding to 712, third and fourth content may be retrieved in response to a second request to provide content to the mobile device. The second request may include a second pipelined request of multiple pipelined requests, such as the second pipelined request 364 of FIG. 3. The second request may identify a third network resource address, such as the third network resource address 308 of FIG. 3. For example, the third network resource address 308 identified in the second request may be an address identifying a third network resource, such as an Internet Protocol (IP) or Media Access Control (MAC) address of the third network resource. The third network resource may include the third network resource address 308, which may correspond to an address of a web site, an FTP site, one or more other network addresses, or any combination thereof. Alternatively, or in addition, the aggregation server may be configured to predictively acquire or prefetch content prior to receiving a request for at least a portion of the content, and the predictively acquired or prefetched content may be stored in a cache associated with or accessible to the aggregation server.

The method includes retrieving third content associated with the second request, where the third content identifies fourth content to be embedded in the third content when the third content is displayed at the browser of the mobile device, such as the browser 322 of the mobile device 320 of FIG. 3. The retrieval of the third and fourth content may be performed in a similar manner as described with respect to retrieving the first and second content described above.

Advancing to 714, a data object including the second content embedded in the first content and the fourth content embedded in the third content is generated. For example, the data object 370 may be generated at the aggregation server 302 that includes the first content 312 with the embedded second content 314 and that also includes the third content 316 with the embedded fourth content 318.

Continuing to 716, the data object 370 may be sent by the aggregation server 302 to the mobile device 320 in response to the first and second requests. The data object may be sent as a single transmission data object, and may be sent within the same keep-alive communication session with the mobile device 320 that was initiated in response to the request to provide content including the multiple pipelined requests 360.

The mobile device 320 may receive the data object 370 and provide the first content 312 with the embedded second content 314 to the browser 322. The mobile device 320 may also provide the third content 316 with the embedded fourth content 318 to the browser 322 or to one or more other requesting applications or devices at the mobile device 320.

As a result of generating and sending pipelined requests, an amount of data signaling and message transmission between the mobile device and the aggregation server may be reduced. Similarly, by sending a single data object including content requested by the mobile device and content embedded within the requested content, content from multiple sources may be received via a single transmission session. As a result, fewer messages are required to be sent from the mobile device.

The systems and methods depicted in FIGS. 1-7 may be used in conjunction with a feature set for content acquisition, referred to herein as “smart caching.” Smart caching allows a user to automatically acquire content from a variety of sources based on a usage pattern, and to purchase such content even when offline. Smart caching allows content providers to pre-emptively push content to a device, based on usage patterns and predictive heuristics. Thus, a user will be able to acquire content both online and offline, without waiting for delivery of the content. Unlike existing mechanisms of preloading content, the user does not pay a penalty in terms of storage space for content that is not consumed. The technology allows a data storage device, such as the data storage device 250 of FIG. 2 and the data storage device 380 of FIG. 3 to appear empty of cached content until such time as the user elects to use the content, at which time it is automatically and transparently converted into usable data.

Smart caching may have one or more of the following features: download of content to removable storage cards or embedded storage; acquisition of content from pre-defined sources using standard connectivity offered to a mobile handset; offline and online billing for content provision; and full integration with video and music player databases.

FIG. 8 illustrates components of a particular embodiment of a smart caching system 800.

The components of the smart caching system 800 are divided into five sections. A server section 801 may include components that store, provide, and maintain content for consumption. The server section 801 includes a content server 802 that may be an aggregation server as described with respect to any of FIGS. 1-3. The server section 801 may include an HTTP web server or any server that is designed to work with a mobile device 811. For example, the mobile device 811 may include a mobile telephone handset.

A Java (trademark) section 803 includes user interface components, players, and other components that may be implemented in Java and may run with an Android (trademark) virtual machine. The Java section 803 includes a feed generation client 814 and a download manager 818 coupled to the content server 802. A policy manager 822 is coupled to the feed generation client 814 and to the download manager 818. A smart cache Application Programming Interface (API) (Java) 826 is coupled to the download manager 818. One or more media players and providers 830 are coupled to the feed generation client 814 and to the smart cache API (Java) 826. A billing manager 836 is also coupled to the smart cache API (Java) 826. The components of the Java section 803 may be coupled via Java dynamic links. The feed generation client 814 may communicate with the policy manager 822 and with the media players and providers 830 via a data structure holding an abstract description of an action to be performed, such as using objects (“intents”) of a Java “Intent” object class. The smart cache API 826 may communicate with the billing manager 836 via intents.

A native section 805 includes components that may be implemented in native code running on a Linux (trademark) platform that underlies the virtual machine implementation. The native section 805 includes a smart cache API (native) 840 that is coupled to the smart cache API (Java) 826 via a Java Native Interface (JNI) (trademark) and coupled to a cache manager 844. The cache manager 844 is coupled to a native cache manager 848 and may manage a cache of data that may be stored at the mobile device 811. For example, the device 809 may include a cache storage accessible to the mobile device 811.

A kernel section 807 includes components that may be implemented within a Linux kernel running within an application processor of the mobile device 811, such as any of the mobile devices 110, 210, or 320 in FIGS. 1-3. The kernel section 807 includes a virtual file system (VFS) 856, a File Allocation Table (FAT) file system (VFAT) 854, a VFAT proxy 852 coupled to the native cache manager 848, a block driver 858, and a bus driver 860, such as a Secure Digital (SD) (trademark) or MultiMediaCard (MMC) (trademark) bus driver.

A device section 809 includes components that run within firmware of a storage device 806 and that may be invoked via an SD Protocol. The storage device 806 includes source firmware 862 and flash memory 864 (e.g. NAND flash). In an alternative embodiment, cache management provided by components illustrated in the native section 805 in conjunction with the kernel system 807 may instead be provided by the smart cache API 826 (Java) interfacing with the source firmware 862 of the storage device 806. For example, the source firmware 862 may implement a cache manager, such as the cache manager 460 of FIG. 4, that is responsive to the smart cache API 826 (Java).

The following paragraphs describe components according to a particular implementation.

The server 802 may be a hypertext transfer protocol (HTTP)-based content provider that can deliver content to a mobile device via an Internet protocol suite, such as including a transmission control protocol (TCP) and an Internet protocol (IP) (TCP/IP). The server 802 may communicate with a content provider object (e.g., a gateway provider) using HTTP or Hypertext Transfer Protocol Secure (HTTPS), and may create a secure session to a firmware application (e.g., via the Advanced Security SD (ASSD) protocol) in order to send keys and content directly to the device 809 (e.g. a memory card).

The server 802 may be specifically optimized to work with the gateway provider by pre-fetching and aggregating content for consumption on a mobile device. The basic architecture of this server 802 can correspond to the architecture illustrated in FIG. 2.

A requestor can be a mobile device (such as the mobile device 210) with a fixed profile and a client-side connection scheduler that requests data in batch mode.

The requestor connects to the aggregator 220 of FIG. 2 using a standard HTTP/1.1 session. The connection is left open using a keep-alive for the duration of the session. At connection time, the requestor sends a pipelined request for pending data that is requested by applications on the device (e.g. the mobile device 210) at the same time. The aggregator 220 inspects a server-side cache 212 to see if some or all of the requests can be satisfied using cached objects already stored on the server. Any data not available within the caches is sent to the analyzer 218, which interprets the request and fetches the data from the fetcher 216.

The fetcher 216 connects to remote services as needed on behalf of the client, such as to access the first network resource 206 and the second network resource 208, using the client's user-agent and standard proxy headers. However, the fetcher 216 does not return this data directly to the requestor. Rather, the fetcher 216 returns the data to the analyzer 218. The analyzer 218 determines embedded links, images, style sheets, JavaScript (trademark) elements, and other data which would typically result in additional requests and interprets them locally, interacting as needed with the fetcher 216. The resulting dataset is returned to the aggregator 220 and stored in the caches, such as the cache 212, for future use. The aggregator 220 then compresses the entire collection of data resulting from the request into a single object, such as the data object 370 of FIG. 3, and returns it to the requestor. The requestor may distribute the received data to client applications as desired.

Another variation includes a scheduler, such as the scheduler 230 of FIG. 2, aligned with the scheduled data requests on the client requestor, such as the mobile device 210. This allows pre-emptive fetching of data on behalf of the client, further reducing the need for client data requests. Instead of sending a series of HTTP requests in a packet, the client may select a specific profile of known data requests, and as a result receive data corresponding to the selected data request profile.

The feed generation clients 814 interface between the players 830 and content servers, and generate feeds for background download. A feed generation client 814 may be specific to a server (e.g. the server 802) and a player (e.g. a player 830).

The Internet server 802 is an external component from which content requested by the feed and download manager 818 is fetched. A target location for the download is managed via the smart caching API 826, which may provide file input/output (I/O) functionality to the device 809.

The download manager 818 iterates over a list of feeds and invokes download actions for feeds based on priority and available space in storage.

The policy manager 822 interacts with the feed generation clients 814 as well as the smart cache database, and sets priority for each feed. Ultimately, the policy manager 822 maintains the feed list/database and determines which feeds will be higher in the download queue. The policy manager 822 also determines when a downloaded file is to be discarded from the cache.

The feed generation clients 814 submit feeds to the policy manager 822, with a suggested priority. The policy manager 822 then determines a feed priority based on the competing demands of the feed generation clients 814, combined with the available space on cache storage. If necessary, the policy manager 822 may invoke the discarding of content (via the smart caching API 826) in order to clear more space for new downloads.

The media players 830 are applications that utilize cached content. The media players 830 may provide a user interface that displays cached content, and invoke the feed generation client 814 that creates recommendation lists and fetches content that can be played on one or more of the media players 830.

When a download is complete, a download complete intent is invoked, triggering a refresh in a database of the requesting media player 830 that shows newly cached content. The media player 830 may call the smart caching API 826 to consume content. Consuming content from the cache manager 844 may trigger a billing action, as may be defined in the feed URI for consumption.

The user may opt to have purchased content, subscriptions (such as podcasts), and free content (but not consigned content) automatically delivered to the file system instead of cached using the smart cache.

The smart caching API 826/840 is a framework that allows applications to utilize smart caching functionality. An Android application can use the smart caching API 826/840 to store and retrieve content that is in the smart cache. The smart caching API 826/840 may provide the following functionality:
Create a discardable file in the smart cache.
Read/write from a file within the smart cache
Verify smart cache integrity
Enumerate cache contents
Transfer a file from the smart cache to the file system (this may invoke a billing action)
Delete a file from the smart cache
Resize the smart cache
Set discarding thresholds
Set cached file permissions

The native cache manager 844 includes userspace applications that allow manipulation of the file system. The applications are invoked from the smart caching API in order to perform the functions enumerated within the API. The native cache manager 844 is also responsible for automatically discarding files when necessary based on the priorities set by the smart caching API and the available storage space.

The native cache manager 844 performs all of the functions referred to in the smart cache API. However, it may delegate some of these functions to the storage device firmware.

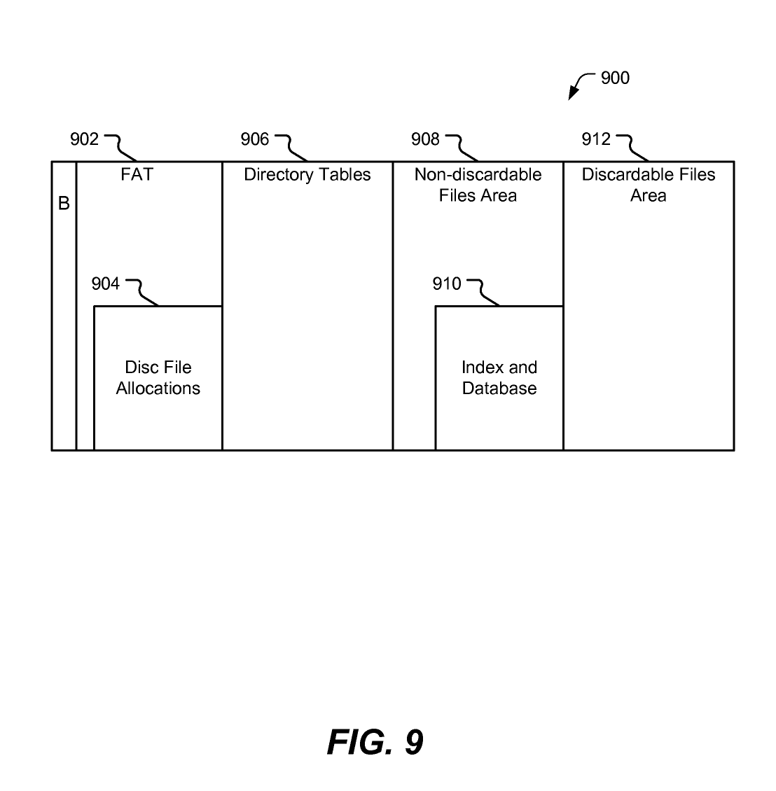

FIG. 9 illustrates an embodiment of a file system 900 that contains discardable files. The file system 900 includes reserved sectors including a boot section (B), a FAT 902 including disc file allocations 904, directory tables 906, a non-discardable files area 908 including an index and database 910, and a discardable files area 912. The file system 900 is similar in structure to a standard FAT32 file system as found in Secure Digital-High Capacity (SD-HC) (trademark) and corresponding high capacity microSD cards.

In a FAT32 file system implementation, the storage medium is comprised of clusters, where each cluster may be a group of 512-byte sectors. The allocation of clusters to files is controlled by two tables—the File Allocation Table (FAT) 902, and the Directory Tables 906. The FAT 902 is an array of clusters, wherein each offset in the array corresponds to a cluster, and the value stored in that offset is a pointer to the next cluster in a chain. The directory tables 906 store a tree of files in the medium, with a 32-bit pointer to the first cluster number (FCN). The pointer indicates both the address of the first cluster in the file, and the corresponding FAT entry. The corresponding FAT entry is the beginning of the cluster chain that describes where the rest of the file is stored. This is illustrated in the following tables.

TABLE 1
Directory Table Information

| | | | FCN | FCN | |
|---|---|---|---|---|---|
| DOS Filename | Extension | Attributes | (high) | (low) | File Size |
| “REALFILE” | “DAT” | “00” | 0000 | 0002 | 0000 24E4 |
| “\xE5CONSIGN” | “000” | “00” | 0000 | 0005 | 0000 8880 |
| “\xE5CONSIGN” | “001” | “00” | 0000 | 000E | 0000 1400 |

TABLE 2
FAT Information

| | | | | | |
|---|---|---|---|---|---|
| F8FF | 0000 0000 | 0000 0003 | 0000 0004 | 0FFF FFFF | 1000 0006 |
| FFFF | (cluster #1) | (cluster #2) | (cluster #3) | (cluster #4) | (cluster #5) |
| (cluster | | | | | |
| #0) | | | | | |
| 1000 0007 | 1000 0008 | 1000 0009 | 1000 000A | 1000 000B | 1000 000C |
| (cluster | (cluster #7) | (cluster #8) | (cluster #9) | (cluster | (cluster #11) |
| #6) | | | | #10) | |
| 1FFF | F000 000F | 0000 0000 | FFFF FFFF | 0000 0000 | 0000 0000 |
| FFFF | (cluster | (cluster | (cluster | (cluster | (cluster #17) |
| (cluster | #13) | #14) | #15) | #16) | |
| #12) | | | | | |
| 0000 0000 | 0000 0000 | 0000 0000 | 0000 0000 | 0000 0000 | 0000 0000 |
| (cluster | (cluster | (cluster | (cluster | (cluster | (cluster #23) |
| #18) | #19) | #20) | #21) | #22) | |

As illustrated, file REALFILE.DAT begins at FCN 2 and has a size of 9444 bytes, which is a bit more than two clusters if the cluster size is 9 sectors or 4 kilobytes (K). Thus, the first cluster number is 2, and entry 2 indicates the next cluster number. Since the entry has the value of 3, the next cluster will be 3. This continues until a terminating value (defined as 0FFFFFFF) is found.

In a conventional FAT system, each entry in the FAT is 32 bits, but only the lower 28 bits are used. The upper four bits are reserved and in FAT32 are set to 0. (Compliant implementations of FAT32 may be required to ignore these upper bits if set on allocated clusters, and to set them to 0 when writing new FAT entries.) In contrast to conventional FAT systems, discardable files are distinguished from regular files by a flag within the upper four bits of the FAT entries of each chain that is associated with the file. This is also illustrated in Table 2.

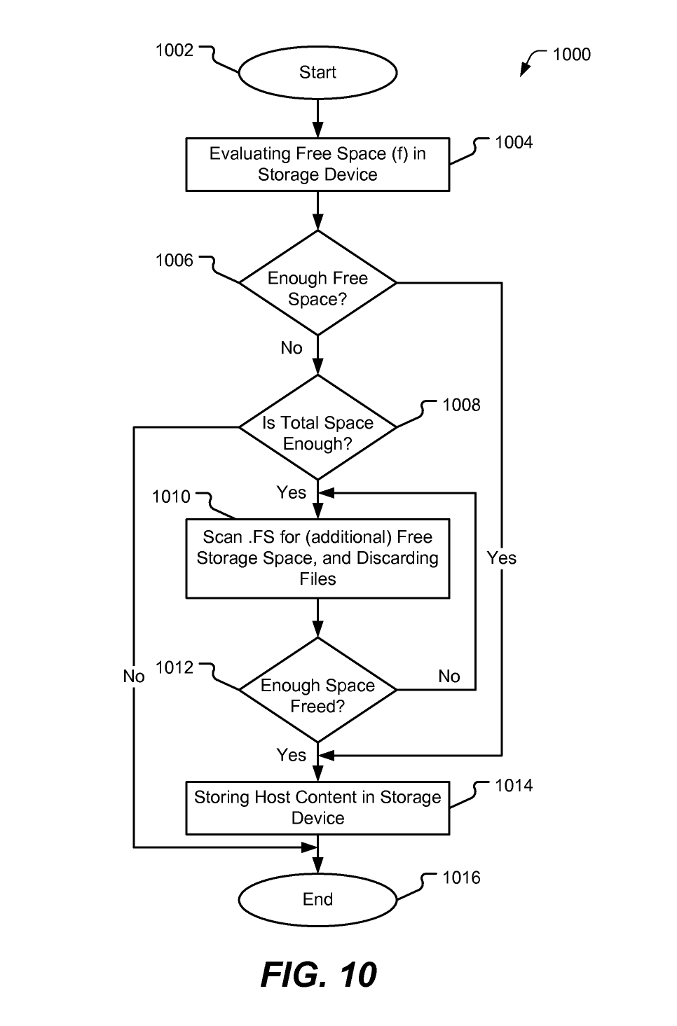

Standard FAT32 drivers may see discardable files as allocated space and will not write over them. However, a simple sweep through the FAT can recover this space, as described in FIG. 10.

FIG. 10 depicts a flowchart 1000 that has a start state, at 1002. Continuing to 1004, free space (f) in a storage device is evaluated. In response to enough free space at the storage device, at 1006, host content may be stored in the storage device, at 1014, and processing continues to an end state, at 1016. In response to not enough free space at the storage device, at 1006, processing advances to 1008. In response to the storage device having insufficient total space, at 1008, processing advances to the end state, at 1016. In response to the storage device having sufficient total space, at 1008, the file system is scanned for (additional) free storage space and discardable files are discarded, at 1010.

When enough space is freed, at 1012, the host content may be stored in the storage device, at 1014. Otherwise, when enough space is not freed, at 1012, processing continues with scanning the file system and discarding files, at 1010.

This loop may be conducted periodically by the native cache manager in order to maintain free space allocations.

Discardable files may be implemented as a variant of the FAT32 file system. While read and write compatibility for standard files is preserved, there are a number of mechanisms that differ between a file system with discardable files and a standard FAT32 file system. These include free space reporting and file system check/repair.

The standard free space recording mechanism for FAT32 uses two mechanisms: reporting the value from the boot sector BPB (FSI_Free_Count multiplied by BPB_BytsPerSec multiplied by BPB_SecPerClus); and counting number of entries in the FAT that have a value of 0 and multiplying by the number of bytes per cluster (derived by multiplying BPB_BytsPerSec and BPB_SecPerClus).

Discardable files should appear as free space. While the value in the BPB can be adjusted to report discardable files as free space, the relevant FAT entries have a nonzero value. Thus, the scanning algorithm used to count the number of free FAT entries should be modified to treat entries with any of the four most significant bits set as free space.

Automated file system check utilities such as chkdsk or fsck.vfat may ignore the upper four bits and may still see what appear to be “orphan” clusters and attempt to repair them by either recovering the corresponding discardable files or deleting them entirely. This is an issue both when directly mounting the microSD card that contains discardable files and when attaching the handset to a PC via USB.

If a microSD card with discardable files is mounted in a regular PC, it will not generally get corrupted, and the system may be designed such that in no case will user data be lost. However, discardable files may be lost.

In an alternative implementation, the entire discardable files implementation is stored in a shadow FAT table. The original two FAT tables allocate the discardable clusters using only the 0xpFFFFFFF (EOF) or 0xp00000000 (unallocated) value, indicating the priority of the file but not its actual chain. If the most significant nibble is nonzero, the third FAT table is consulted to determine the actual cluster chain sequence. This improves security by preventing automated file system check utilities from recovering full files. The cluster chains need not be sequentially allocated when using a third FAT table, although cluster sizes may be aligned on flash erase block boundaries as much as practical to prevent a reduction in performance. If the clusters are marked as allocated, they will appear as allocated in unsupported environments. If the clusters are marked as free, they appear as unallocated, but may be allocated in unsupported environments, while retaining the discardable flag.

The third FAT table is stored in a standard file in the root of the microSD file system. The file may be encrypted.

Feeds are lists of content URIs that, when referenced, return server content to the cache. A feed may be in the form of an Atom or RSS feed, or may be in a proprietary format that is suitable for a specific server. Since each server is different, feed generation is done using multiple providers, each tied to its server. The output of the feed generator may be a content stream which is sent to the server when content is requested.

Typically, a feed will consist of a set of requests to specific types of content derived from user requests or purchase history. The feed may be as simple as a URI that includes a user identifier (ID) or as complex as a series of channels that a user subscribed to.

Feed generators may be invoked by players or any other application or system component. Typically implemented as services, feed generators are not expected to have an independent user interface.

A sample feed generator that uses RSS may be implemented as part of smart caching. Additional feed generators may be implemented as part of integration with specific content providers.

The policy manager 822 of FIG. 8 is responsible for determining which of a set of competing download requests will be executed in order to utilize the smart cache in an efficient or optimal manner. This may be done using a set of business rules that take into account the following factors: the relative priority of each feed generator, as determined by the user, the operator, or both; the relative priority of each content object, as determined by the content provider; and attributes of each content object such as size, publication date, and popularity.

The policy manager 822 may be customizable for specific products by adjusting these rules.

The download manager 818 of FIG. 8 may be an extended version of the Android Download Manager. Designed as a plug-in replacement, it subclasses existing Download Manager functionality, allowing an application within Android to download content to the smart cache as well as standard storage.

In addition to the standard functionality provided by Android for immediate downloads, the download manager 818 includes the ability to delay downloads until specific conditions occur. These conditions can include:
Availability of a specific route (Wi-Fi (trademark), direct network, or a specific 3G connection)
A specific power condition (AC power, charging, or a battery charge of over a specific level)
A range of times (for example, only between midnight and 5 AM)
Available storage of above a certain threshold

Conditions are set on a per-URI basis. For example, a client of the Download Manager may submit a URI for download, with parameters stating that it may be downloaded only when a Wi-Fi connection is available, the device is charging, and there is at least 1.5 gigabytes (GB) of available storage in the smart cache.

The download manager 818 can direct content to either the smart cache or regular storage, as specified by the download request. If content is downloaded to the smart cache, its priority is set at file creation.

The download manager 818 may understand standard data transfer protocols such as HTTP/S and file transfer protocol (FTP).

While an Android application may be able to invoke the download manager 818 (using the Intent system) a specific permission may be required to download to the smart cache. The Android software development kit (SDK) does not offer direct access to the Download Manager using an API, so the Intent system is used for smart cache actions as well as direct downloads. The ACTION_GET_DATA intent only allows immediate download. Using the smart cache system may require interaction with the Download Manager Provider and its API. (Only signed and System applications with the ACCESS_DOWNLOAD_MANAGER permission can access the Download Manager Provider.)

It should be noted that the /cache directory and its functionality may not be overridden by the smart cache, nor is data that is downloaded using the ACTION_GET_DATA intent downloaded to the smart cache.

Data downloaded to the smart cache may be only visible to the user ID (UID) that invoked the download. This prevents applications from accessing data (and thus invoking billing events) unless they requested the data in the first place. (This restriction is also in place in the Cupcake version of the Download Provider.) However, a flag may be set in the smart cache intent specifying other UIDs that may access the file, allowing a trusted player to access files that were requested by a feed generator, even if the feed generator does not share a UID with the player. In addition, the intent may specify that a file is available to all UIDs.

When a file is transferred from the smart cache to the file system, it may become world-readable and world-writable.

A new permission (ACCESS_SMART_CACHE) may be required in the manifest of the calling application in order to successfully invoke the ACTION_GET_DATA_CACHED intent.

The standard Download Manager Provider is used to interface with the Download Manager. This is extended for the smart cache interface to provide additional columns, such as the billing interface, discarding priority, and other locations.

Notifications may be handled in the same way for smart cached and immediate downloads. The notifications for smart cached files may be done using a Desktop and the Notification Manager.

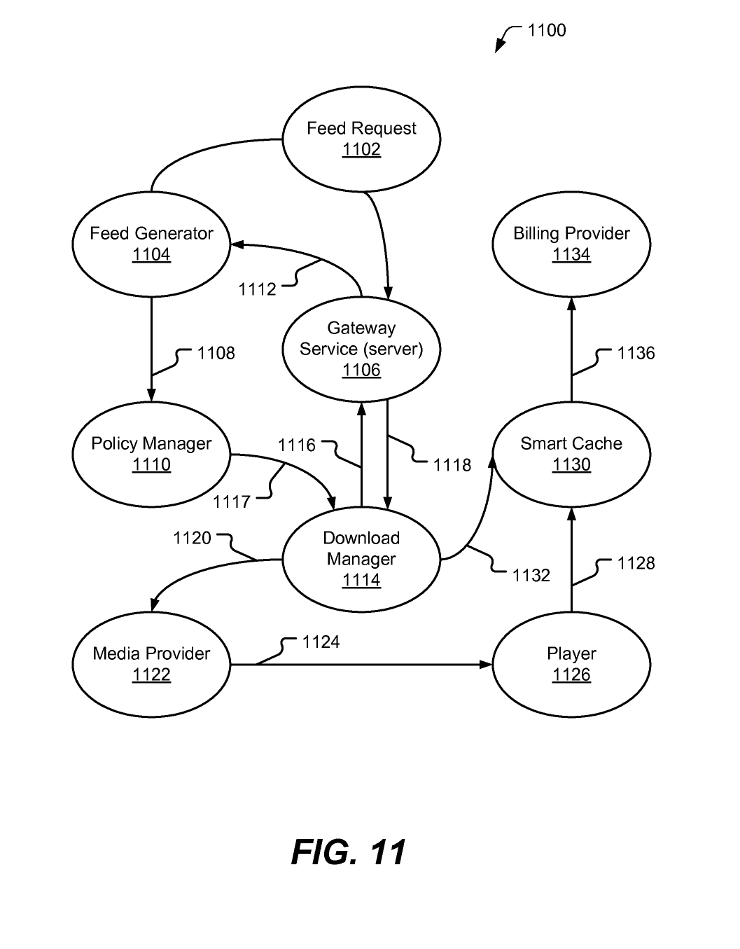

A smart caching application data flow is illustrated in FIG. 11. The smart caching application flow begins with the feed generator 1104, which generates a feed request 1102. The feed request is a message to the server 1106 for an updated feed of content to deliver to the user. The format of the feed request is proprietary to the server, as is its response. The gateway service proxies the request to the server 1106, and returns a response 1112, which is in a format relevant to the specific feed generator 1104.

Following this, the feed generator 1104 sends a list of URIs and associated metadata 1108 to the policy manager 1110. The policy manager 1110 sorts and prioritizes the URIs according to policy decisions, and then outputs a list of URIs to download 1117 to the download manager 1114, which queues them for download at the appropriate time and with the appropriate connection. As conditions allow, URIs 1116 are sent to the gateway service and the content is returned 1118 to the download manager 1114.

The download manager 1114 delivers content 1132 to the smart cache 1130, and metadata describing the content 1120 to the media provider 1122, which stores the relevant metadata in databases accessible to the player 1126. When the player 1126 activates a file in response to a user request, the content request 1128 is sent to the smart cache 1130. The content request 1128 may trigger a billing event 1136, which is sent to the billing provider 1134. A billing manager such as the billing manager 836 of FIG. 8 may approve or decline the activation.

Following the triggering of the billing event 1136 and its approval, content is played by the player 1126.

The smart cache native JNI is invoked from the download manager 818 of FIG. 8 as well as players that have permission to access the smart cache and the specific file being accessed. The API may be packaged as a shared library that can be invoked using the <uses-library> facility.

The smart caching system may provide a socket-based command protocol that enables application processor use and invocation of applications residing within storage device firmware. Logical block addresses containing smart cache data may be secured such that read access without authentication will be denied. The native smart cache manager 848 of FIG. 8 will authenticate to the card on behalf of authorized applications and a server may directly communicate with the storage device via the socket proxy, and set the relevant permissions. In this implementation, an attempt to directly read the sectors containing smart cache data will fail, and no further encryption or access control is necessary.

An access control system in smart caching is enforced on the native level. Because the smart cache API is invoked as JNI, it runs in the context of the invoking user. The native smart cache interface enforces an access control list (ACL) on each cached file that contains a list of UIDs authorized to access the file. This ACL is set on file creation and can be modified by the creator/owner UID of the file.

The smart cache does not encrypt file contents. However, the third FAT technique described above may be employed for security. The third FAT table is encrypted with AES-128 encryption using a key derived from data stored within the handset, but not within the storage media. Since clusters are not allocated sequentially when using the third FAT table, encrypting the third FAT is sufficient to make it difficult to reconstruct the file without the proper key. However, this technique may be only appropriate for media stream files, and not for confidential documents.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Accordingly, the disclosure and the figures are to be regarded as illustrative rather than restrictive.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A data storage device comprising:
a host interface;
a controller coupled to the host interface; and
a memory array coupled to the controller,
wherein the host interface is configured to enable the data storage device to be operatively coupled to the host device,
wherein first content includes a reference to a source of second content to be embedded in the first content, wherein the first content is retrievable via access to a resource, and wherein upon retrieval, the reference is replaced by the second content such that the second content is embedded in the first content, and
wherein the controller is configured to
receive data of the resource, such received data including the second content embedded in the first content,
store the received data at the memory array and,
when the data storage device is operatively coupled to the host device, provide the second content embedded in the first content to the host device in response to receiving a request for the first content.

2. The data storage device of claim 1, wherein the reference to the source of the second content includes a second network resource address.

3. The data storage device of claim 2, wherein the first content is accessible to the resource via a first network resource address at a data network, and wherein the second content is retrievable via access to the second network resource address at the data network and not retrievable via access to the first network resource address.

4. The data storage device of claim 3, wherein the second network resource address includes a uniform resource locator (URL).

5. The data storage device of claim 1, wherein the memory array includes a cache and wherein the received data is stored at the cache.

6. The data storage device of claim 5, wherein the memory array further includes a user data area and wherein the controller is further configured to respond to a command to render the received data accessible by writing the received data from the cache to the user data area.

7. The data storage device of claim 6, wherein the memory array further includes a file system table corresponding to the user data area, and wherein the controller is further configured to update the file system table to indicate the received data.

8. The data storage device of claim 7, wherein the controller is further configured to send a message to the host device after updating the file system table to cause the host device to load the updated file system table.

9. A method of storing data, the method comprising:
at a data storage device configured to be operatively coupled to a host device, wherein first content is retrievable via access to a resource, wherein the first content includes a reference to a source of second content to be embedded in the first content, and wherein upon retrieval, the reference is replaced by the second content such that the second content is embedded in the first content, performing
receiving the first content and the second content;
storing the first content and the second content as data that includes the second content embedded in the first content; and
in response to receiving a request for the first content, providing the second content embedded in the first content to the host device.

10. The method of claim 9, wherein the data storage device includes a memory array that includes a cache and wherein the data is stored at the cache.

11. The method of claim 10, wherein the memory array further includes a user data area, and further comprising:
receiving a command to render the data accessible; and
in response to receiving the command, writing the data from the cache to the user data area.

12. The method of claim 11, wherein the memory array further includes a file system table corresponding to the user data area, and further comprising, in response to receiving the command, updating the file system table to identify the data.

13. The method of claim 12, further comprising sending a message to the host device after updating the file system table to cause the host device to load the updated file system table.

14. A method of storing data, the method comprising:
at a data storage device configured to be operatively coupled to a host device, wherein first content is retrievable via access to a resource, wherein the first content includes a reference to a source of second content to be embedded in the first content, and wherein upon retrieval, the reference is replaced by the second content such that the second content is embedded in the first content, performing
receiving data from the host device when the data storage device is operatively coupled to the host device, wherein the received data includes the second content embedded in the first content;
storing the received data; and
in response to receiving a request for the first content, providing the second content embedded in the first content to the host device.

15. The method of claim 14, wherein the received data further includes fourth content embedded in third content,
wherein the third content is retrievable via access to the resource and includes a reference to a source of the fourth content to be embedded in the third content, and wherein upon retrieval, the reference to the source of the fourth content is replaced by the fourth content such that the fourth content is embedded in the third content, and
wherein the controller is further configured to provide the fourth content embedded in the third content to the host device in response to receiving a request for the third content.

16. The method of claim 15, wherein the received data is received from the host device as a single data object.

17. The method of claim 14, wherein the data is received in accordance with a data request schedule stored at the data storage device.

18. The method of claim 14, wherein the received data is prefetched data that is selected according to a usage profile independent of a user request for the first content.

19. A data storage device comprising:
a host interface;
a controller coupled to the host interface; and
a memory array coupled to the controller, the memory array including a user data area and a cache,
wherein the host interface is configured to enable the data storage device to be operatively coupled to the host device,
wherein first content is retrievable via access to a resource wherein the first content includes a reference to a source of second content to be embedded in the first content, and wherein upon retrieval, the reference is replaced by the second content such that the second content is embedded in the first content,
wherein the controller is configured to receive data of the resource, such received data including the second content embedded in the first content,
wherein the controller is configured to store the received data at the cache,
wherein, in response to receiving a command to render the first content accessible, the controller is configured to write the received data to the user data area from the cache, and
wherein, in response to receiving a request for the first content, the controller is configured to provide the second content embedded in the first content from the user data area to the host device when the data storage device is operatively coupled to the host device.

20. The data storage device of claim 19, wherein the memory array further includes a file system table corresponding to the user data area, and wherein the controller is configured to update the file system table to indicate the first content in response to receiving the command.

21. The data storage device of claim 20, wherein the controller is configured to send a message to the host device after updating the file system table, wherein the message is configured to cause the host device to load the updated file system table.
